(19) United States
(12) Patent Application Publication
(10) Pub. No.: US 2009/0123162 A1
(43) Pub. Date: May 14, 2009

(54) CONTROLLER FOR OPTICAL TRANSMISSION DEVICE

(75) Inventor: Tomoto TANAKA, Kitami (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/252,786

(22) Filed: Oct. 16, 2008

(30) Foreign Application Priority Data
Oct. 19, 2007 (JP) 2007-272923
Oct. 15, 2008 (JP) 2008-266583

(51) Int. Cl. H04B 10/04

(52) U.S. Cl. 398/183

(57) ABSTRACT

A controller supplies a driving signal to an optical modulator for modulating light from a light source in accordance with the driving signal, a low frequency signal being superposed on the driving signal. A bias unit monitors a low frequency component of the modulated light and controls bias of the optical modulator. A compensation unit controls the intensity of the light so as to compensate for refractive index variation of the optical modulator which is caused by variation of the bias.

The present application is related to and claims the benefit of foreign priority to Japanese application 2007-272923, filed on Oct. 19, 2007 in the Japan Patent Office and Japanese application 2008-266583, filed on Oct. 15, 2008 in the Japan Patent Office, which are incorporated herein by reference in its entirety.

### BACKGROUND OF THE INVENTION

An intensity modulation—direct detection system (direct modulation system) is known as one of simplest systems out of systems for performing electro-optic conversion in an optical communication system. In the direct modulation system, light emission and quenching of light from a light source are directly controlled. Direct modulation is performed by switching current flowing in a laser diode (LD) on or off in accordance with a data signal of “1” or “0”, for example.

Though the direct modulation system is a simple system, it induces wavelength chirping in an output optical signal. The direct modulation system induces wavelength chirping because it switches the LD on or off itself directly, which affects transmission quality adversely. Specifically, the wavelength chirping occurring in the optical signal due to the direct modulation and chromatic dispersion of an optical fiber through which the optical signal propagates result in delay of propagation speed in the optical signal. Therefore, the waveform of the optical signal is deformed during propagation of the optical signal through the optical fiber. Thus, it is difficult to perform long-distance transmission and high-speed transmission of the optical signal. This adverse affect is more intense as the data transmission speed (bit rate) increases.

An external modulation system is another system for performing electro-optic conversion in the optical communication system. According to the external modulation system, light which is used in high-speed transmission of 2.5 Gbps, 10 Gbps or the like and continuously output from a light source such as LD or the like is switched on (light transmission) or off (light shielding) in accordance with “1” or “0” of the data signal by an external modulator, in order to avoid the effect of the wavelength chirping caused by the direct modulation system.

An LiNbO₃ external modulator (Lithium Niobate modulator; hereinafter referred to as “LN modulator”) is known as one of the external modulators. FIG. 2 is a diagram showing the configuration of the LN modulator. In the LN modulator, drift of a bias voltage occurs due to a direct component of a signal to be applied, temperature, time-lapse deterioration or the like. The bias voltage is associated with the operating point of the LN modulator, and the control of the bias voltage is necessary to properly keep the operation of the LN modulator.

In FIG. 2, bias voltage control (Auto Bias Control; ABC) is executed to control the bias voltage of the LN modulator. Specifically, a reference signal which is subjected to amplitude modulation by using a low frequency signal is supplied to the LN modulator through a driving circuit of the LN modulator. A low frequency signal component is detected from an optical signal output by the LN modulator to be compared to a reference signal, thereby performing feedback control on the bias voltage. When the bias voltage operates at the optimum point, the low frequency signal is modulated in reversed phase. Thus, the frequency component thereof is not contained in the output signal, and the low frequency signal component detected from the optical signal is equal to zero.

Furthermore, in the LN modulator, when the operating point of the modulator is varied by changing the bias voltage, the phase variations at the rising and falling portions of the optical signal to be output are reversed, so that the chirping of the optical signal (the code of a parameter) is reversed.

Still furthermore, in the external modulation system, the optical output of the transmitter is kept constant, and thus the output control of the light source is carried out. For example, the driving current control based on the automatic power control (APC) is executed on the basis of a monitor result of backward output light intensity of LD.

The techniques described above are disclosed in JP-A-2-50189 or JP-A-10-164018, for example.

### SUMMARY OF THE INVENTION

In one aspect, a controller comprises a signal supplier for supplying a driving signal to an optical modulator for modulating light from a light source in accordance with the driving signal, a low frequency signal being superposed on the driving signal; a bias unit for monitoring a low frequency component of the modulated light and controlling bias of the optical modulator; and a compensation unit for controlling the intensity of the light so as to compensate for refractive index variation of the optical modulator which is caused by variation of the bias.

In one aspect, a control method of an optical transmitter having an optical modulator for modulating light from a light source in accordance with a driving signal on which a low-frequency component is superposed comprises supplying the driving signal to the optical modulator; monitoring a low frequency component of the modulated light to control bias of the optical modulator; and controlling the intensity of the light so as to compensate for refractive index variation of the optical modulator which is caused by variation of the bias.

The above-described embodiments of the present invention are intended as examples, and all embodiments of the present invention are not limited to including the features described above.

### BRIEF DESCRIPTION OF THE DRAWINGS

FIG. 1 is a diagram showing an optical transmitter according to an embodiment;

FIG. 2 is a diagram showing an example of an output signal waveform of an external modulator (LN modulator);

FIGS. 3A to 3D are diagrams showing examples of the optical output waveform when a bias voltage varies;

FIG. 4 is a diagram showing variation of average transmittance when the bias voltage varies;

FIG. 5 is a diagram showing a control method when chirping is switched;

FIG. 6 is a diagram showing the relationship between the output of a light source and the output of the transmitter when chirping is switched;

FIG. 7 is a diagram showing the relationship between the light source output and the transmitter output when correction is executed at the chirp switching time;

FIG. 8 is a diagram showing a compensation control method at the start time;

FIG. 9 is a diagram showing the relationship between the light source output and the transmitter output at the start time;

FIG. 10 is a diagram showing the relationship between the light source output and the transmitter output when correction at the start time is executed;

FIG. 11 is a diagram showing the optical transmitter of an embodiment;

FIG. 12 is a diagram showing the relationship between the output of an LN modulator and the transmitter output at the chirp switching time (no correction);

FIG. 13 is a diagram showing the relationship between the average transmittance variation of the LN modulator and the transmittance correction of VOA at the chirp switching time;

FIG. 14 is a diagram showing the relationship between the LN modulator output and the transmitter output at the chirp switching time (correction is executed);

FIG. 15 is a diagram showing a compensation control method at the start time; and

FIG. 16 is a diagram showing a control method at the chirp switching time.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

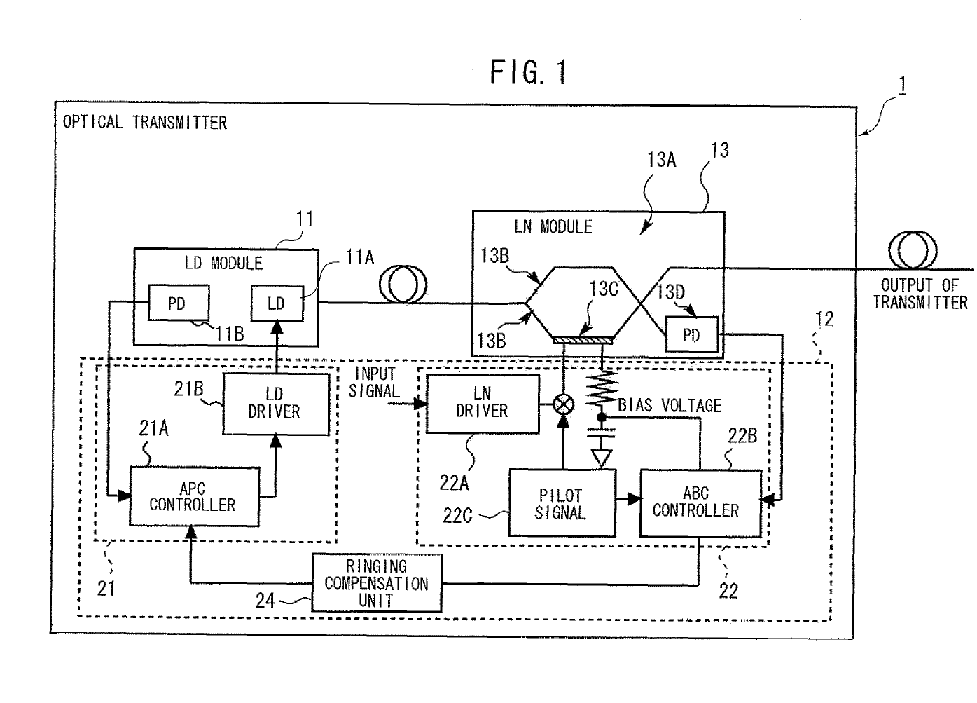

FIG. 1 is a diagram showing an optical transmitter (optical transmission device) according to the present invention. A light source 11 outputs light having a predetermined wavelength, and that can be LD (Laser Diode), for example. In an external modulator 13, a light waveguide 13B and a control electrode 13C are formed on a substrate 13A having an electro-optic effect. The external modulator 13 switches on/off the intensity of light to be output therefrom by changing the refractive index of light propagating through the light waveguide 13B in accordance with a voltage applied to a control electrode 13C so that the light from the light source 11 is modulated to generate an optical signal. In FIG. 1, the external modulator 13 is an LN modulator using Lithium Niobate(LiNbO₃) as the substrate 13A. The external modulator 13 has an optical detector (PD) 13D for detecting an optical output.

The controller 12 is equipped with a light source driving unit 21 for driving the light source 11, a modulation controller 22 for controlling the LN modulator 13, an attenuation controller 23 for controlling VOA 14, and a ringing correcting unit (compensator, correction amount calculator) 24 for compensating bias variation based on the modulation controller 22.

In the light source driving unit 21, the APC controller 21A controls driving current to the light source 11 of the light source driving unit 21B on the basis of the intensity of backward output light of the light source (LD) 11 which is detected by phase detector (PD) 11B as the optical detector.

The modulation controller 22 has an LN modulator driving unit (signal supplier) 22A, a bias unit (ABC controller) 22B and an oscillator 22C.

The LN driving unit (signal supplier) 22A sets an input signal as a driving signal having a predetermined level, and supplies the driving signal concerned to the LN modulator 13.

The driving signal deviates with respect to the operating point of the LN modulator 13 due to DC voltage or temperature and time-lapse deterioration. The bias unit 22B adjusts the bias voltage to be applied to the LN modulator 13 so as to correct this deviation. Specifically, a pilot signal having a lower frequency than the driving signal generated by the oscillator 22C is superposed on the driving signal, and applied to the LN modulator 13. The bias unit 22B extracts the frequency component concerned from the modulated optical signal detected by PD 13D, and compares the frequency component to the pilot signal. The bias unit 22B adjusts the bias voltage to be applied to the LN modulator 13 so as to correct the thus-detected deviation of the driving signal with respect to the operating point of the LN modulator 13.

In the process of controlling a bias voltage to an optimum operating point from the control start time and at the α-parameter switching time, an LN modulator is driven at an operating point other than the optimum operating point. Therefore, the average transmittance from the LN modulator varies greatly, and thus the optical output also varies greatly, so that discontinuous variation (ringing) occurs in the output light of the LN modulator.

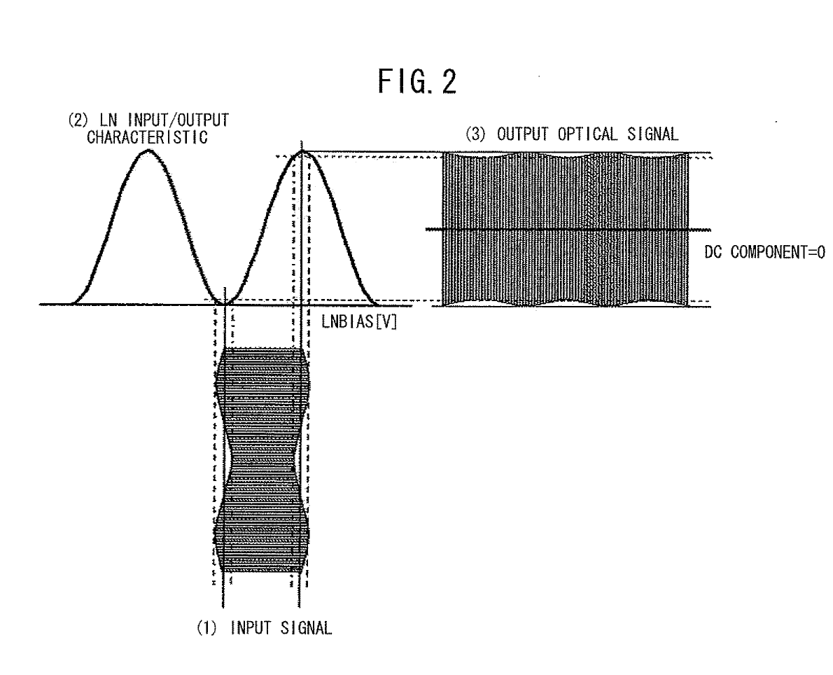

FIG. 2 is a diagram showing the waveform of an input signal on which a low frequency component is superposed and the waveform of an output optical signal in the LN modulator 13. As shown in FIG. 2, under the bias control of the bias unit 22B, the low frequency component of the input signal is smoothened and thus it is removed from the output signal under the state that no deviation occurs in the driving signal (input signal) with respect to the operating point.

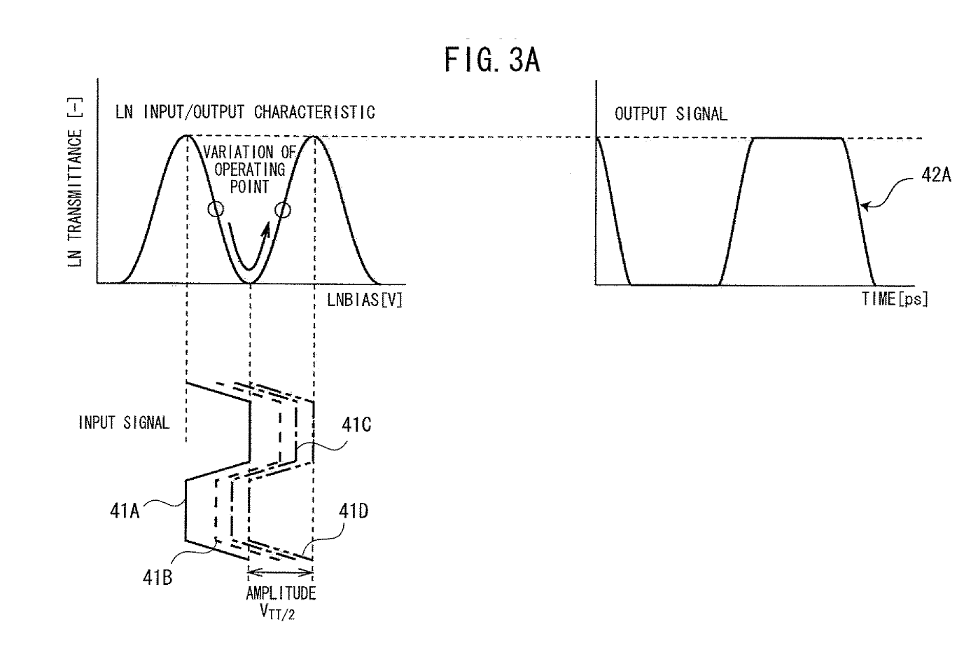

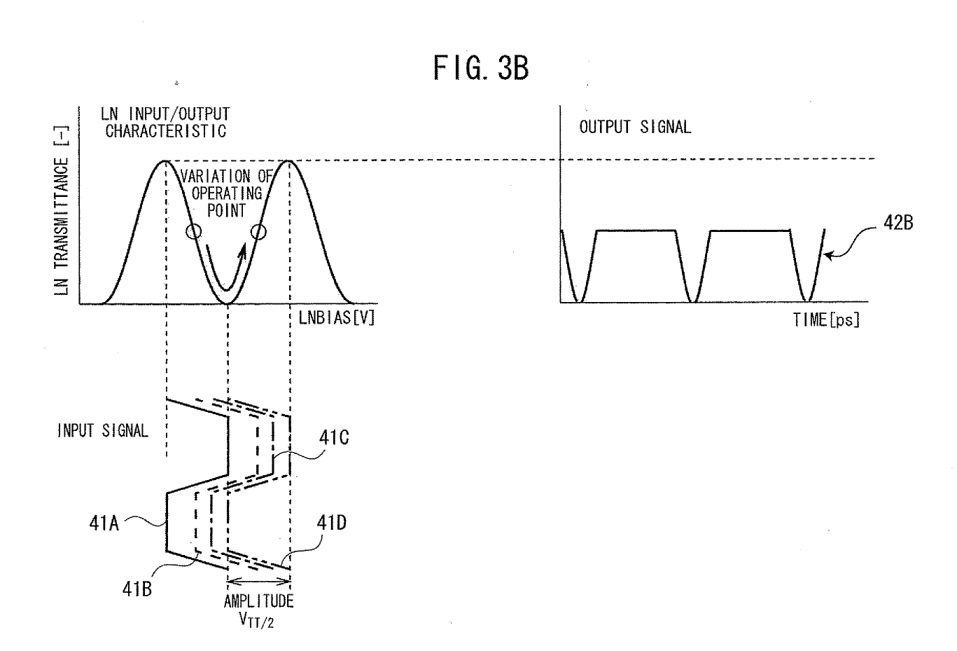

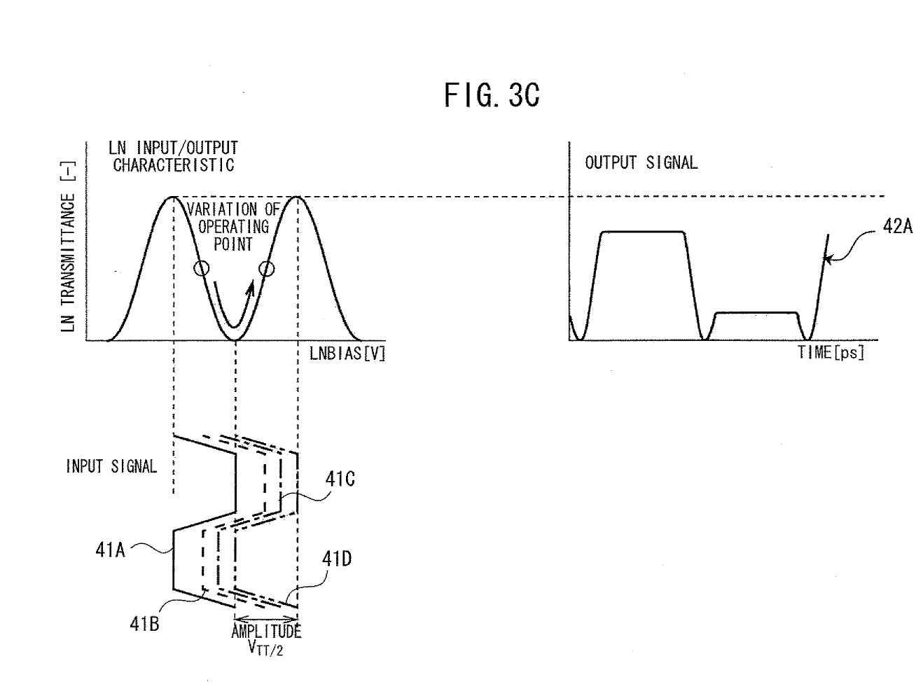

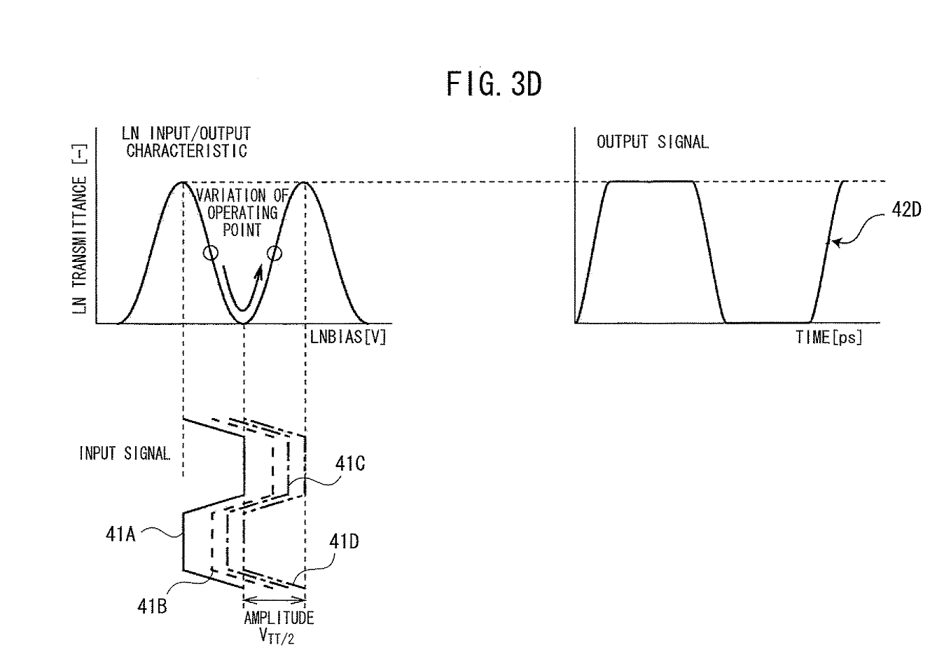

FIGS. 3A to 3D are diagrams showing the output waveform of an external modulator (LN modulator) when the bias voltage varies. As shown in FIGS. 3A to 3D, when the bias voltage varies, the driving condition of the LN modulator varies, and the output waveform varies, so that the average transmittance of the LN modulator 13 (shown in FIG. 1) varies greatly.

Specifically, in FIGS. 3A to 3D, when the operating point (a parameter) is switched, the input varies from a signal 41A to 41D until the bias voltage varies to the optimum point, and the output varies from a waveform 42A to 42D. Accordingly, even when the laser output is controlled to be fixed by APC and thus the intensity of light input to the LN modulator is controlled to be fixed, the output variation (ringing) occurs till the operating point of the LN modulator is changed.

The bias voltage control (ABC) used in the LN modulator cannot prevent the output variation (ringing) by stopping the driving of the light source because it is required to input light from the light source to the LN modulator. Accordingly, after the light emission of the light source is started, the output variation (ringing) occurs in some area while the bias voltage control is started.

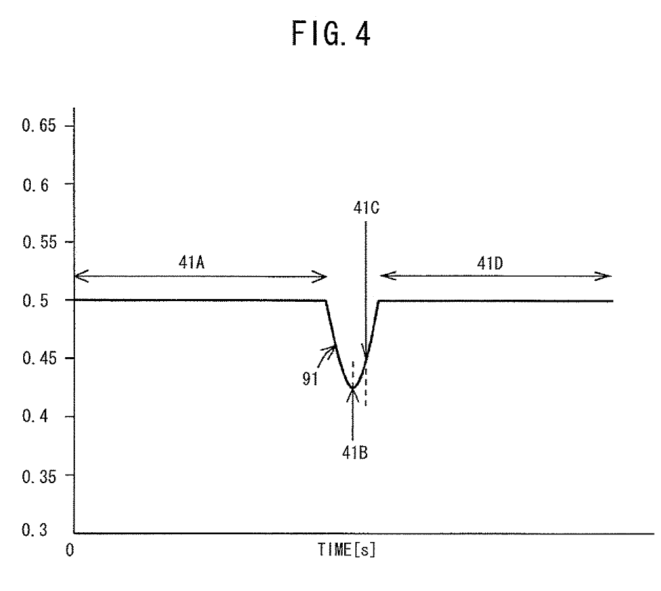

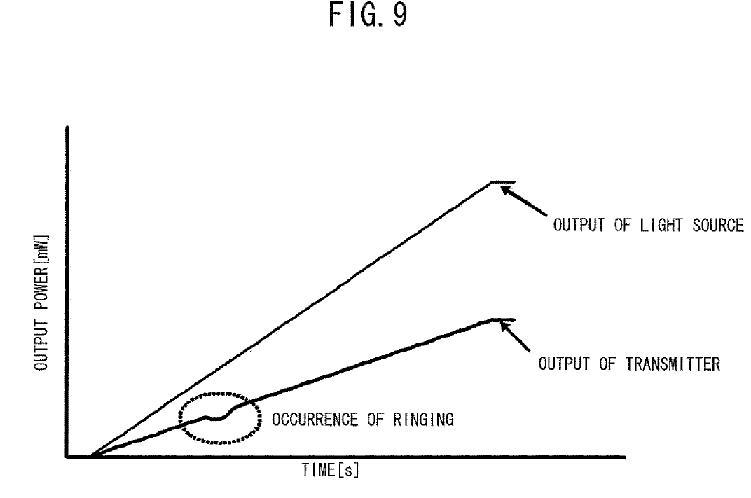

For example, as shown in FIG. 9, when the output (intensity) of the light source linearly increases to a target value Lo, a variation 91 occurs in the average transmittance of the LN modulator as shown in FIG. 4, and thus a variation 92 appears in the output light as shown in FIG. 9.

Accordingly, in the process of switching the a-parameter, occurrence of ringing is unavoidable. In the transmitter using the wavelength divisional multiple system, occurrence of ringing may affect the channel of a proximate wavelength, and thus it is unfavorable.

FIG. 4 is a diagram showing the relationship of the average refractive index to the bias voltage. A ringing corrector 24 (shown in FIG. 1) controls the intensity of the light source so as to correct the refractive index variation of the LN modulator 13 (shown in FIG. 1) which is caused by the variation of the bias. In this embodiment, at the light emission start time of the light source (at the start time of ABC) or at the chirp switching time, the ringing is suppressed by varying the intensity of the light source.

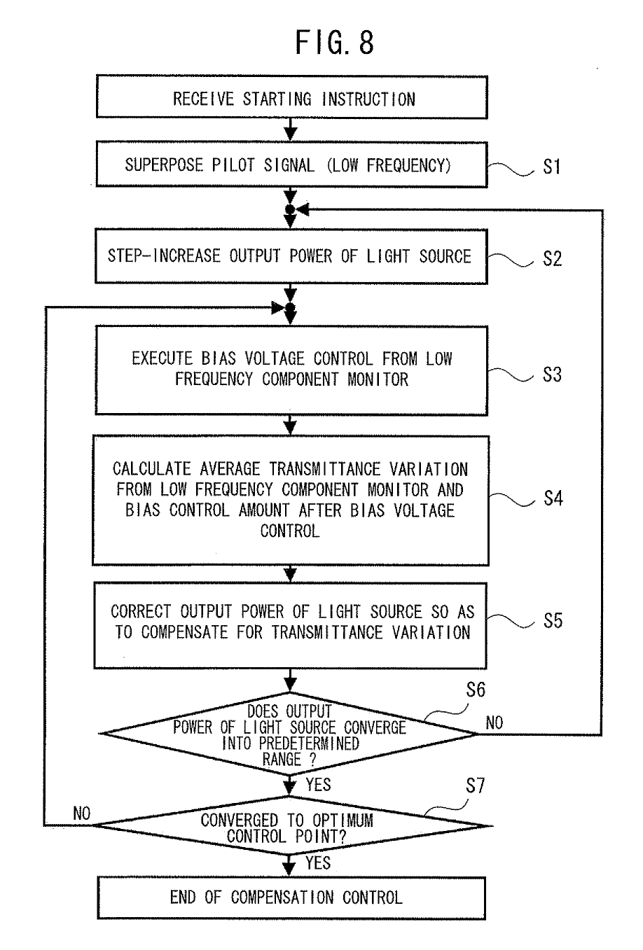

FIG. 8 is a diagram showing the method of controlling the optical transmitter 1 (shown in FIG. 1) at the start time, that is, at the light emission start time of the light source. When power is turned on or a starting instruction is input, the pilot signal having the low frequency component is superposed on the driving signal (operation 1; S1). Subsequently, the light source driving unit 21 of the controller 12 (shown in FIG. 1) supplies the light source 11 with driving current (S2) to increase the output power of the light source.

After light from the light source is input to the LN modulator 13 and PD 13 detects the low frequency component of the power of the transmitted light, the bias unit 22B starts the automatic bias control (ABC) (S3).

When detecting the start of the control of the bias unit 22B, the ringing corrector 24 monitors the control amount of the bias voltage and the low frequency component of the optical output from the LN modulator 13 to calculate the average transmittance variation amount of the LN modulator 13 (S4).

The ringing corrector 24 detects the detection signal from PD 13D or the variation of the bias voltage from the bias unit 22B, or it detects a signal which is transmitted from the bias unit 22B and indicates that the control is started, whereby the detection of the start of the control in S4 is performed.

The average transmittance variation of the LN modulator 13 which varies due to the bias variation, that is, the drastic decrease of the average transmittance as shown in FIG. 4 is experimentally determined in advance. As described above, FIG. 9 is a diagram showing the ringing occurring in the output of the transmitter at the start time due to the refractive index variation.

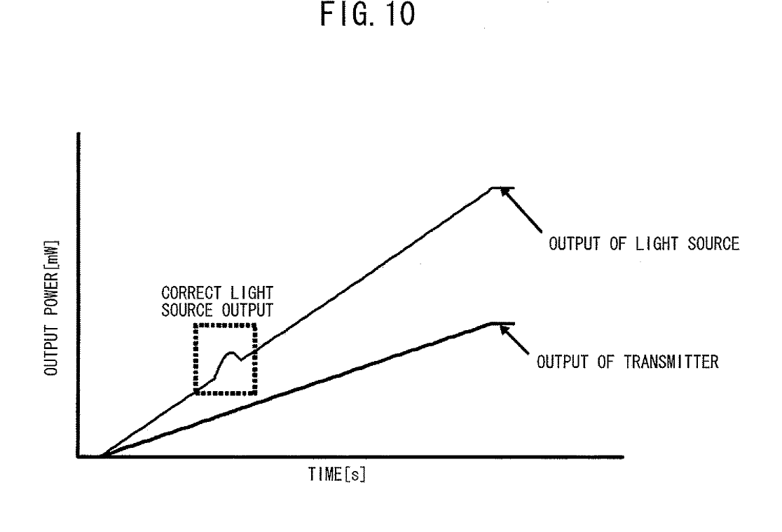

The ringing corrector 24 corrects the output of the light source 11 on the basis of the average transmittance variation amount determined in S4 (S5). As shown in FIG. 10, the ringing corrector 24 increases the intensity of the light source 11 in conformity with the variation of the average transmittance, whereby the effect of the average transmittance variation of the LN modulator 13 on the optical signal is offset and thus the ringing is removed. Therefore, the optical output of the optical transmitter 1 increases linearly.

Subsequently, it is judged whether the intensity of the light source 11 converges into a predetermined range. If the intensity of the light source 11 does not converge into the predetermined range, the processing returns to S2 (S6). If the intensity of the light source 11 converges into the predetermined range, it is judged whether the bias control converges to the optimum control point (S7). If the bias control does not converge to the optimum control point, the processing returns to S3. If the bias control converges to the optimum control point, the compensation control is finished.

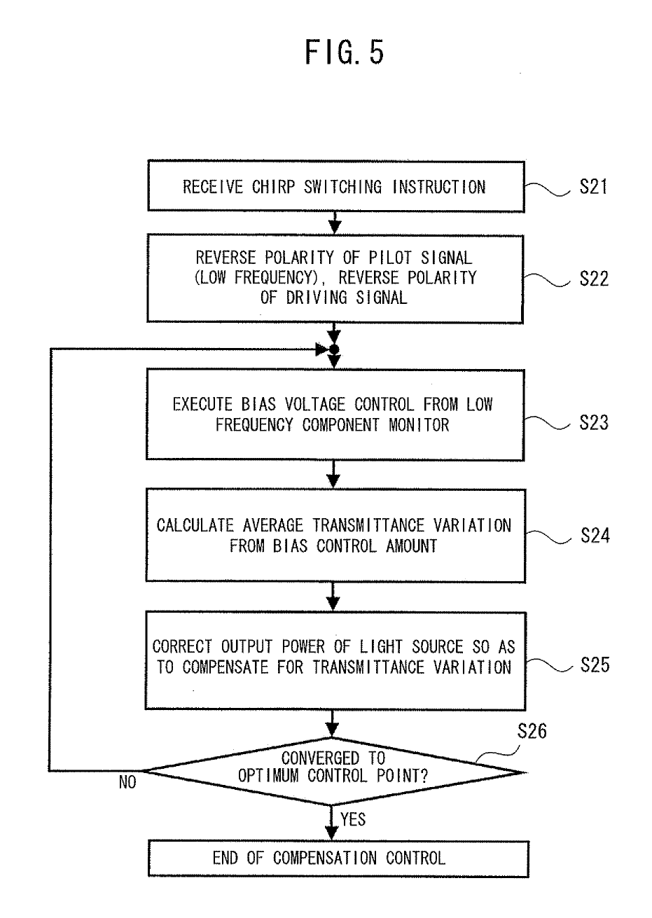

FIG. 5 is a diagram showing the control method at the chirp switching time. When a bias switching instruction is input to the modulation unit 1 (shown in FIG. 1) by an operator's operation and received by the controller 12 (S21), the bias unit 22B switches the voltage of the bias to reverse the polarities of the pilot signal and the driving signal. That is, the input signal shown in FIGS. 3A to 3D is changed from the driving signal 41A to the driving signal 41D (S22).

The low frequency component of light transmitted through the LN modulator 13 is monitored by PD 13D, and the bias unit 22B carries out the automatic bias control (ABC) (S23).

Furthermore, the ringing corrector 24 monitors the control amount of the bias voltage and the low frequency component from the LN modulator 13, and calculates the average transmittance variation amount of the LN modulator 13 (S24).

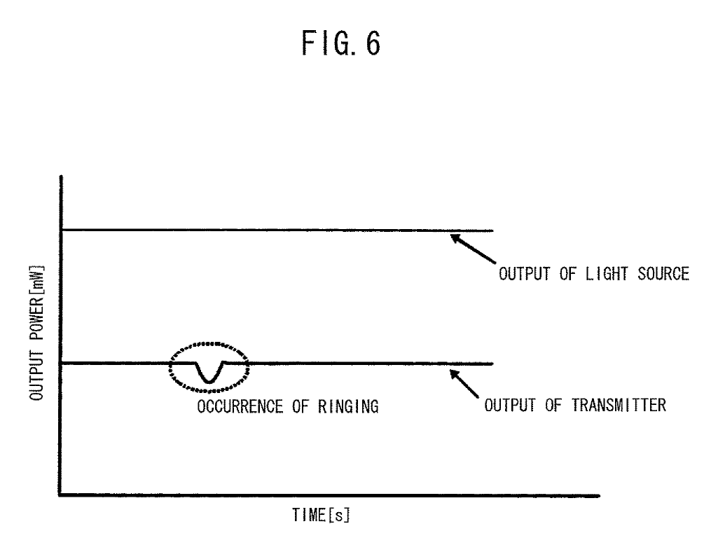

The variation of the average transmittance of the LN modulator 13 which is caused by the bias variation, that is, the drastic decrease of the average transmittance as shown in FIG. 4 is experimentally determined in advance. FIG. 6 is a diagram showing the ringing occurring in the output of the transmitter at the start time due to the variation of the average transmittance.

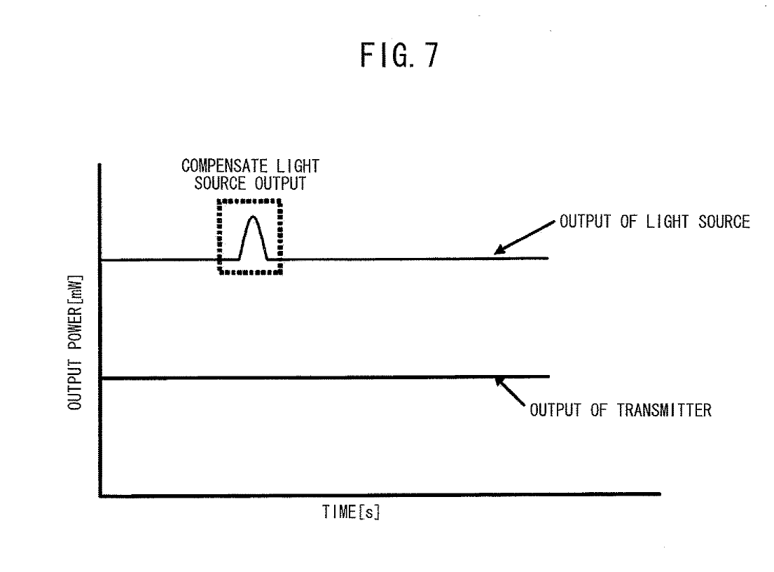

The ringing corrector 24 corrects the output of the light source 11 on the basis of the transmittance variation amount determined in S24 (S25). Specifically, as shown in FIG. 7, the effect of the average transmittance variation of the LN modulator 13 is offset by increasing the intensity of the light source 11 in conformity with the variation of the average transmittance, whereby the ringing is removed from the optical output of the optical transmitter 1.

Furthermore, it is judged whether the bias control converges to the optimum control point (S7). If the bias control does not converge to the optimum control point, the processing returns to S23. If the bias control converges to the optimum control point, the compensation control is finished.

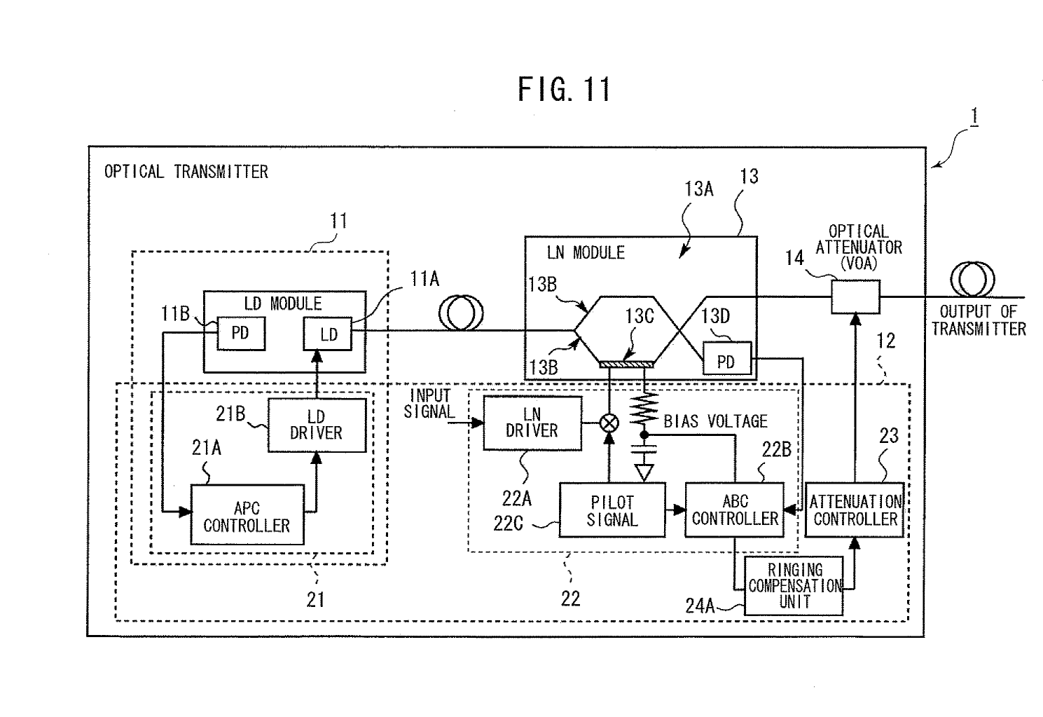

The optical transmitter shown in FIG. 11 is equipped with a variable optical attenuator (attenuator: VOA). The ringing corrector controls VOA unlike the optical transmitter shown in FIG. 1 in which the ringing corrector controls the light source unit. The other configuration of the optical transmitter shown in FIG. 11 is the same as the optical transmitter shown in FIG. 1.

The ringing corrector 24A shown in FIG. 11 controls the intensity of the optical signal modulated in the LN modulator 13 so as to compensate for the average transmittance variation of the LN modulator which is caused by the variation of the bias or the like. Specifically, the ringing is suppressed by controlling the transmittance of VOA 14, that is, the attenuation amount at the light emission start time of the light source (at the start time of the ABC control) or at the chirp switching time.

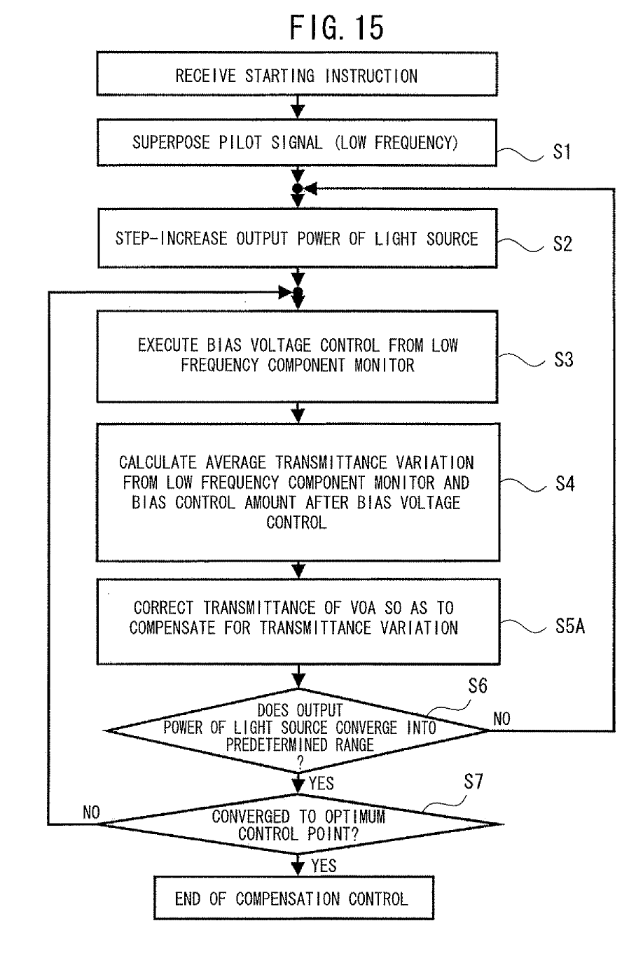

FIG. 15 shows the control method at the start time, that is, at the light emission start time of the light source. First, when power is turned on or the start instruction is input, the pilot signal having the low frequency component is superposed on the driving signal (S1), and the light source driving unit 21 of the controller 12 supplies the driving current to the light source 11 (S2) to increase the output power of the light source.

When light from the light source is input to the LN modulator 13 and the low frequency component of the power of the light transmitted through the LN modulator is detected by PD 13D, the bias unit 22B starts the automatic bias control (ABC) (S3).

When detecting that the control of the bias unit 22B is started, the ringing corrector 24 monitors the control amount of the bias voltage and the low frequency component of the output light from the LN modulator 13 to calculate the average transmittance variation amount of the LN modulator 13 (S4). FIG. 9 shows ringing occurring in the output of the transmitter at the start time due to the average transmittance variation.

The ringing corrector 24A corrects the transmittance of VOA 14 on the basis of the average transmittance variation amount determined in S4 (S5A). As shown in FIG. 10, the ringing corrector 24A increases the transmittance of VOA 14 in conformity with the reduction of the average transmittance of the LN modulator 13 to offset the effect of the average transmittance variation of the LN modulator 13, whereby the ringing is removed and the optical output of the optical transmitter 1 increases linearly.

Subsequently, it is judged whether the intensity of the light source 11 converges into a predetermined range. If the intensity of the light source 11 does not converge into the predetermined range, the processing returns to S2 (S6). If the intensity converges into the predetermined range, it is judged whether the bias control converges to the optimum control point (S7). If the bias control does not converge to the optimum control point, the processing returns to S3. If it converges to the optimum control point, the compensation control is finished.

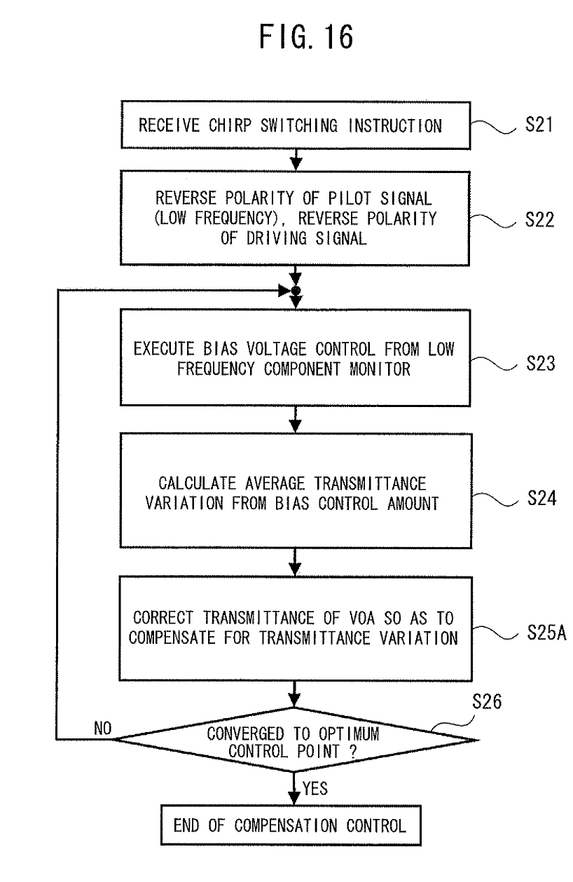

FIG. 16 shows the control method at the chirp switching time. When a bias switching instruction is input to the modulation unit 1 by an operator's operation and the controller 12 receives this instruction (S21), the bias unit 22B switches the bias voltage to reverse the polarities of the pilot signal and the driving signal. Specifically, in FIG. 3, the polarity of the driving signal is changed from the driving signal 41A to the driving signal 41D (S22).

The low frequency component of the light transmitted through the LN modulator 13 is monitored by PD 13D, and the bias unit 22B performs the automatic bias control (ABC) (S23).

Furthermore, the ringing corrector 24 monitors the control amount of the bias voltage and the low frequency component from the LN modulator 13 to calculate the refractive index variation amount of the LN modulator 13 (S24).

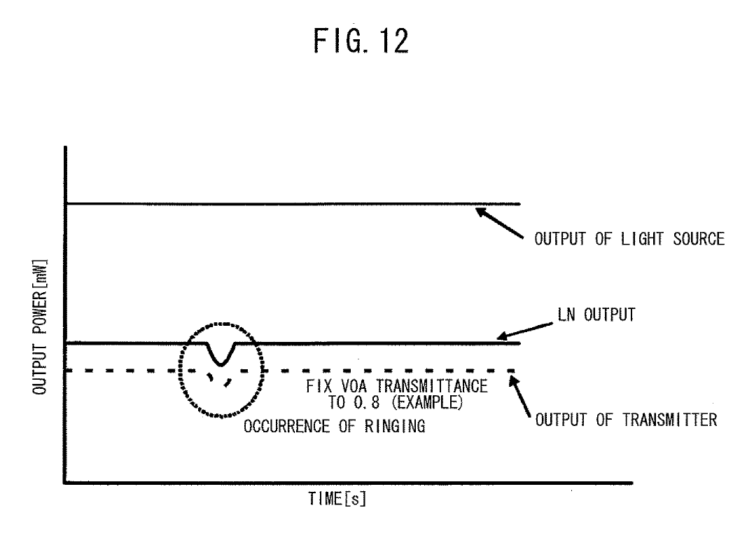

At this time, the refractive index variation of the LN modulator 13 which is caused by the bias variation, the drastic decrease of the refractive index as shown in FIG. 4 in this embodiment is experimentally determined in advance. FIG. 12 is a diagram showing ringing occurring in the output of the transmitter at the start time due to this refractive index variation.

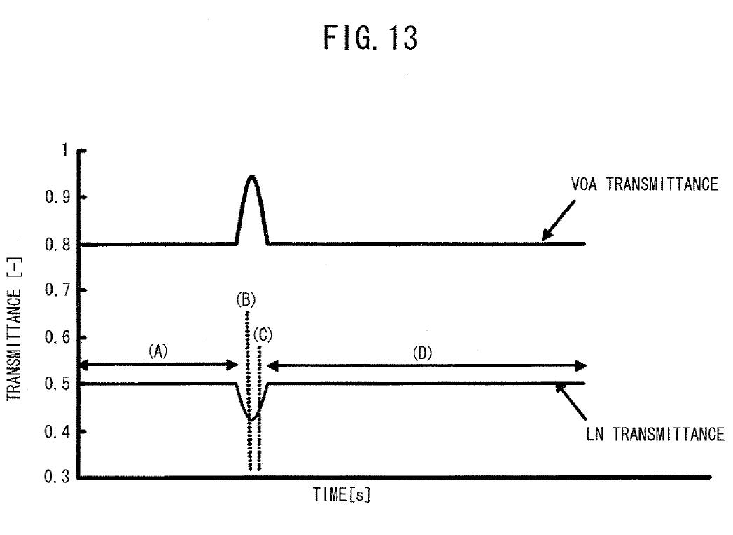

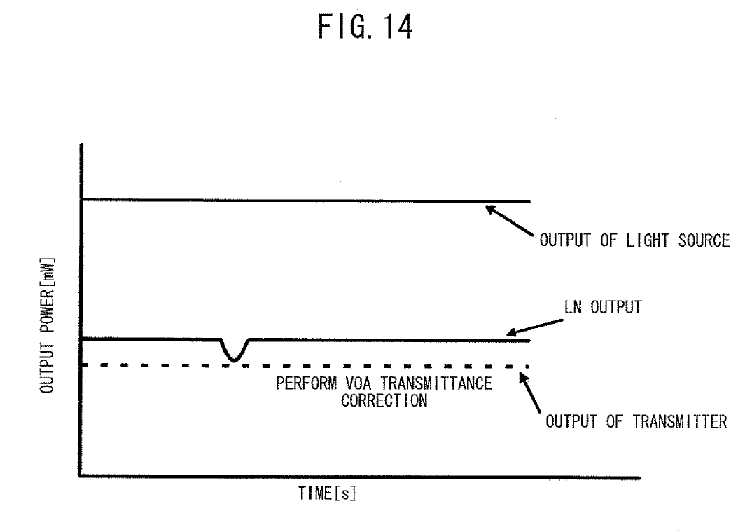

The ringing corrector 24A corrects the refractive index of VOA 14 on the basis of the refractive index variation amount determined in S24 (S25A). Accordingly, the ringing corrector 24A increases the refractive index of VOA 14 as shown in FIG. 13 in conformity with the reduction of the refractive index of the LN modulator 13 to thereby offset the effect of the refractive index variation of the LN modulator 13 and remove ringing from the optical output of the optical transmitter 1 as shown in FIG. 14.

Furthermore, it is judged whether the bias control converges to the optimum control point (S7). Here, if the bias control does not converge to the optimum control point, the processing returns to S23. If the bias control converges to the optimum control point, the compensation control is finished.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A controller comprising:
a signal supplier for supplying a driving signal to an optical modulator for modulating light from a light source in accordance with the driving signal, a low frequency signal being superposed on the driving signal;
a bias unit for monitoring a low frequency component of the modulated light and controlling bias of the optical modulator; and
a compensation unit for controlling the intensity of the light so as to compensate for refractive index variation of the optical modulator which is caused by variation of the bias.

2. The controller according to claim 1, wherein the compensation unit controls driving power of the light source to compensate for the refractive index variation of the optical modulator.

3. The controller according to claim 1, wherein the compensation unit controls an attenuation amount of an optical attenuator for attenuating the modulated light to compensate for the refractive index variation of the optical modulator.

4. The controller described in any one of claims 1 to 3, wherein the compensation unit calculates a variation amount of refractive index of the optical modulator to the variation amount of the bias, and compensates the refractive index variation on the basis of the calculated variation amount.

5. A control method of an optical transmitter having an optical modulator for modulating light from a light source in accordance with a driving signal on which a low-frequency component is superposed, comprising:
supplying the driving signal to the optical modulator;
monitoring a low frequency component of the modulated light to control bias of the optical modulator; and
controlling the intensity of the light so as to compensate for refractive index variation of the optical modulator which is caused by variation of the bias.

6. The control method according to claim 5, wherein the refractive index variation of the optical modulator is compensated by controlling driving power of the light source.

7. The control method according to claim 5, wherein the refractive index variation of the optical modulator is compensated by controlling an attenuation amount of an optical attenuator for attenuating the modulated light.

8. The control method according to claim 5, wherein a variation amount of refractive index of the optical modulator to the variation amount of the bias is calculated, and the refractive index variation is compensated on the basis of the calculated variation amount.

9. An optical transmission device, comprising:
a light source;
an optical modulator for modulating light from the light source; and
a controller for controlling the light source and the optical modulator; wherein,
the controller comprises:
a signal supplier for supplying a driving signal to an optical modulator for modulating light from a light source in accordance with the driving signal, a low frequency signal being superposed on the driving signal;
a bias unit for monitoring a low frequency component of the modulated light and controlling bias voltage of the optical modulator; and
a compensation unit for controlling the intensity of the light source so as to compensate for refractive index variation of the optical modulator which is caused by variation of the bias.

10. An optical transmission device, comprising:
an optical modulator for modulating light from a light source;
an optical attenuator for attenuating light modulated in the optical modulator; and
a controller for controlling the optical modulator and the optical attenuator, wherein, the controller comprises:
a signal supplier for supplying a driving signal to an optical modulator for modulating light from a light source in accordance with the driving signal, a low frequency signal being superposed on the driving signal;
a bias unit for monitoring a low frequency signal of the modulated light and controlling bias voltage of the optical modulator; and
a compensation unit for controlling an attenuation amount of the optical attenuator so as to compensate for refractive index variation of the optical modulator which is caused by variation of the bias.
